(19) United States
(12) Patent Application Publication
(10) Pub. No.: US 2021/0141632 A1
(43) Pub. Date: May 13, 2021

(54) AUTOMATED SOFTWARE PATCHING FOR VERSIONED CODE

(71) Applicant: salesforce.com, inc., San Francisco, CA (US)

(72) Inventor: Ana Laura Felisatti, Buenos Aires (AR)

(21) Appl. No.: 16/679,010

(22) Filed: Nov. 8, 2019

(51) Int. Cl. G06F 8/658; G06F 8/41; G06F 9/445; H04L 29/08

(52) U.S. Cl. CPC G06F 8/658; G06F 8/41; H04L 67/10; H04L 67/34; G06F 9/445

(57) ABSTRACT

Methods, systems, and devices supporting automatic software updating are described. A server may implement an automated software patching system for versioned code. A patch server may retrieve a production version of code and code updates to apply to the production version of code based on a patch request. The patch server may determine an updated version of code based on the production version of code and the code updates, retrieve a file difference between the updated version of code and the production version of code, and determine a compilation difference based on the retrieved file difference. The updated version of code may be associated with a set of binary files, and the application server may determine a subset of the binary files that are associated with the file difference. The patch server may package the subset of binary files into a software patch for the production version of code.

### FIELD OF TECHNOLOGY

The present disclosure relates generally to database systems and data processing, and more specifically to automated software patching for versioned code.

### BACKGROUND

A cloud platform (i.e., a computing platform for cloud computing) may be employed by many users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

Some cloud platforms may generate and deploy software patches that fail to fix errors present in production code. The software patches may additionally or alternatively introduce new errors into the production code and require a user to manually create the software patch. For example, a user may create a software patch, name the software patch, and deploy the software patch to a user device. In some examples, the user may name the software patch incorrectly and introduce one or more errors into the production code as a result. For example, a user device may fail in referencing a software patch due to an incorrect naming of the software patch. A software patch may additionally or alternatively degrade system performance. For example, a software patch may contain unnecessary files or code, and as a result, require a large amount of resources (e.g., memory, storage space, disk space, processing units, etc.) to store and install the software patch. Unnecessary files or code may result in unnecessary operations at a user device and may degrade system performance and/or user experience.

### BRIEF DESCRIPTION OF THE DRAWINGS

FIG. 1 illustrates an example of a system for managing software patches that supports automated software patching for versioned code in accordance with aspects of the present disclosure.

FIG. 2 illustrates an example of a software updating system that supports automated software patching for versioned code in accordance with aspects of the present disclosure.

FIG. 3 illustrates an example of a software update deployment system that supports automated software patching for versioned code in accordance with aspects of the present disclosure.

FIG. 4 illustrates an example of a software patch creation process that supports automated software patching for versioned code in accordance with aspects of the present disclosure.

FIG. 5 illustrates an example of a process flow that supports automated software patching for versioned code in accordance with aspects of the present disclosure.

FIG. 6 shows a block diagram of an apparatus that supports automated software patching for versioned code in accordance with aspects of the present disclosure.

FIG. 7 shows a block diagram of a patching manager that supports automated software patching for versioned code in accordance with aspects of the present disclosure.

FIG. 8 shows a diagram of a system including a device that supports automated software patching for versioned code in accordance with aspects of the present disclosure.

FIG. 9 through 11 show flowcharts illustrating methods that support automated software patching for versioned code in accordance with aspects of the present disclosure.

### DETAILED DESCRIPTION

Some cloud platforms may use a patching system to deploy software patches to users to provide software updates and/or software fixes. A patch may be generated for a user or a code version (e.g., a production version of code), and the patch may address one or more issues in the code version. In some cases, generating a software patch may involve reviewing a version control system (e.g., Git) to identify one or more code updates, retrieving the one or more updates, building a patch based on the one or more updates, and naming the patch. In some examples, a patch may fail a build process (e.g., fail to compile) and/or may contain errors. For example, a patch may be missing one or more binary files and may therefore contain or cause errors (e.g., compilation errors, runtime errors, etc.). In an additional or alternative example, a patch may contain binary files that are not associated with the one or more issues. A patch that contains binary files that are not associated with the issues may degrade system performance (e.g., inefficiently using excess processing resources to install the patch).

A patching system may implement an automatic patcher to update a production version of code. An automatic patcher may improve system efficiency and decrease an amount of errors that may be encountered when updating a production version of code. A server (e.g., a patching server) may retrieve a production version of code and one or more updates (e.g., commits) to the production version of code from a code repository (e.g., a version control server, a Git server, etc.). The patching server may determine an updated version of the code based on the one or more updates. In some cases, the patching server may compile, build, or test the updated version of the code. The patching server may retrieve a file difference between the updated version of the code and the production version of the code from the version control server. In some cases, the file difference may correspond to a set of binary files, and the patching server may determine a subset of binary files that corresponds to compilation difference between the updated version of the code and the production version of the code. The patching server may package the subset of binary files into a software patch for the production version of the code. In some examples, the patching server may determine additional binary files to include in the software patch based on the file difference. Additionally of alternatively, the patching server may include binary files in the software patch that are associated with an issue related to the production version of the code, and the patching server may refrain from including binary files in the software patch that are not associated with the issue.

In some cases, the server may receive a request for a software patch from a user device. The request for the software patch may indicate information about software associated with the user device. For example, the request for the software patch may indicate a version of code (e.g., a production version) associated with the user device. In additional or alternative examples, the request for the software patch may be associated with an identifier (e.g., an issue identifier). In some cases, the server may retrieve a production version of code based on the request message. The server may generate a name for the software patch based on the indicated version of code, an identifier associated with the request message, one or more code updates, or any combination thereof. In some examples, a software patch naming convention may be defined and used when naming software patches. For example, a naming convention may indicate that software patch names may include a production version of code followed by an issue identifier. Implementing a naming convention may allow users to quickly and consistently locate software patches based on the naming convention. In some cases, a naming convention may improve the efficiency of the server. For example, the server may generate a software patch and may store the software patch according to the naming convention. The server may determine, based on the naming convention, that a software patch associated with a production version of code and/or an issue is stored at the server.

In some cases, the server may determine a superset of code classes. For example, a retrieved file difference may include a set of code classes, and the server may determine a superset of code classes including the set of code classes as well as class extensions associated with the set of code classes. In some examples, the set of code classes may include accessible classes (e.g., public classes, external classes, etc.), and the superset of code classes may include accessible classes as well as non-accessible classes (e.g., private classes, internal classes, etc.). In some examples, the server may determine a compilation difference based on the superset of code classes. Determining a compilation differences based on the superset of code classes may, in some examples, improve patch reliability. In some cases, determining a compilation difference may improve patch reliability and prevent errors (e.g., runtime errors, compilation errors, etc.) by identifying all new binary files for the patch that are not present in the production version of the code.

Aspects of the disclosure are initially described in the context of an environment supporting an on-demand database service. Aspects of the disclosure are further described with respect to a software updating system, a software update deployment system, a software patch creation process, and a process flow diagram. Aspects of the disclosure are further illustrated by and described with reference to apparatus diagrams, system diagrams, and flowcharts that relate to automated software patching for versioned code.

FIG. 1 illustrates an example of a system 100 for managing software patches that supports automated software patching for versioned code in accordance with aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level, and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

In some cases, the data center 120 may include multiple databases, servers, or other types of systems. For example, the data center 120 may include a patch server and/or a code repository. In some cases, the patch server may support automated software patching for versioned code. The cloud platform 115 or an application server of subsystem 125 may retrieve versioned code (e.g., a production version of code) from a code repository. The patch server may determine an updated version of code, retrieve a file difference from the code repository, and determine a compilation difference between production version of code and the updated version of code. The compilation difference may include binary files, where a binary file may be a computer-readable file stored in a binary format (e.g., for execution). The patch server may package the binary files into a software patch for the production version of code. In some examples, the patch server may deploy (e.g., transmit) the software patch to a cloud client 105 or contact 110. Automated software patching for versioned code may support maintaining robust and efficient code.

In some other systems, a user operating a software updating system may generate large software updates that fail to fix errors present in production code. The software updates may introduce new errors into the production code and require a user to manually identify files to include in the updates and/or name the update. A user may create a software patch, name the software patch, and deploy the software patch to a user device. In some examples, the user may name the software patch incorrectly and introduce one or more errors into the production code as a result. In some cases, a software update or patch may be large and degrade system performance. For example, a software patch may contain unnecessary files or code, and as a result, require a large amount of resources (e.g., memory resources, processing resources, etc.) to store and install the software patch. Unnecessary files or code may result in unnecessary operations and degrade system performance and/or user experience. In some cases, a software update or patch may not undergo testing, and errors present in the software update or patch may be discovered when the software update or patch is introduced in the production code. Therefore, the system may generate large, error-prone, and inconsistently names software updates or patches.

In contrast, the system 100 may implement automated software patching for versioned code, which may efficiently reduce software patch sizes, consistently name software patches, and thoroughly test software patches. For example, an application server of subsystem 125 may retrieve a file difference between an updated version of code and a production version of code, and the application server may determine a compilation difference based on the retrieved file difference. In some examples, the compilation difference may include a subset of binary files. For example, the updated version of code may be associated with a set of binary files, and the application server may determine a subset of the set of binary files that are associated with the file difference between the updated version of code and the production version of code. Automated software patching for versioned code may support generating a software patch name based on an identifier of a request message, a production version of code, one or more code updates, or any combination thereof. For example, the patch name may depend on the input for creating the patch, including the version (e.g., the version tag) and ticket (e.g., the identifier for the fixes requested by a user). The automated software patching for versioned code may support building and testing a software patch. Based on automated software patching for versioned code, a server may generate reliable software patches in a highly efficient and robust manner.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

Users of computing and cloud platforms may request a software patch to address an issue (e.g., a software bug, a lack of a software feature, a code error, etc.) in a version of code (e.g., a production version of code). For example, the software version may not contain a feature that the user wants or needs, and the user may request the feature. A system supporting automated software patching for versioned code may generate a software patch based on the request. In some cases, the software patch may contain binary files that support the feature. The software patch may therefore target the feature (e.g., without containing extra or unnecessary files unrelated to the feature) and installing the patch may allow the software version implemented by the user to support the requested feature.

FIG. 2 illustrates an example of a software updating system 200 that supports automated software patching for versioned code in accordance with aspects of the present disclosure. The software updating system 200 includes a patch server 205 and a version control server 210. The system 200 may implement aspects of a system 100 as described with reference to FIG. 1. For example, a patch server 205 and/or a version control server 210 may be an examples or components of a data center 120.

The patch server 205 may represent aspects of an application server, communication server, data processing server, database server, cloud-based server, server cluster, virtual machine, container, or some similar data processing device or system. The patch server 205 may communicate with other devices such as the version control server 210 (e.g., via one or more application programming interfaces (APIs)). The patch server 205 may retrieve a version of code (e.g., a production version of code) from the version control server 210. In some cases, the patch server 205 may receive an indication of an issue associated with a production version of code and retrieve the production version of the code based on the indication. The production version of the code may, in some cases, be associated with a code version (e.g., a code release, a code date, etc.) and/or a user (e.g., a user requesting the patch). The patch server 205 may additionally or alternatively retrieve one or more code updates (e.g., commits) to apply to the production version of the code. These commits may fix an issue or support an improvement in the production version of the code indicated by a user requesting the patch. In some cases, the patch server 205 may receive an indication of the version of the code and/or an indication of the one or more updates from the version control server 210.

The patch server 205 may determine an updated version of the code. In some examples, the patch server 205 may determine the updated version of the code based on the production version of the code and/or the one or more code updates. The patch server 205 may, for example, determine the updated version of the code based on a previous version of the code stored in a code repository (e.g., at the version control server 210, such as a production version of the code). The patch server 205 may apply one or more changes (e.g., one or more commits) to the previous version of the code to obtain the updated version of the code. This may involve merging one or more code branches in the code repository to obtain an updated branch containing the previous version of the code with the commits (e.g., where the commits are rebased and added to a base branch representing the previous version of the code in the code repository). In some cases, the patch server 205 may compile and/or test the updated version of the code. Additionally or alternatively, the updated version of the code may be compiled and/or tested at a testing server. The patch server 205 may determine that the updated version of the code successfully compiles. The patch server 205 may additionally or alternatively determine that the updated version of the code passes a testing procedure (e.g., a local test suite, a remote test suite, etc.). In some examples, the patch server 205 may determine that one or more test cases have failed. The patch server 205 may, for example, provide an indication that the one or more test cases have failed and may refrain from (or block) storing the updated version of the code in the version control server 210 and distributing the software patch.

The patch server 205 may retrieve a difference (e.g., a file difference 225) between the updated version of the code and the production version of the code. For example, the patch server 205 may transmit a difference request to the version control server 210, and the difference request may, in some cases, include the updated version of the code and the production version of the code, or an indication of the updated version of the code, an indication of the production version of the code, or both. In some examples, the indication of the updated version of the code may be based on one or more code updates (e.g., commits). In some cases, the patch server 205 may transmit the difference request if the updated version of the code passes the tests. The version control server 210 may transmit a file difference 225 response to the patch server 205. For example, the difference request may be an example of a Git difference (diff) checker operation, and the version control server 210 may compare branches, tags, commits, or some combination thereof to determine the file difference 225. In some cases, the file difference 225 may correspond to a set of binary files. The file difference 225 may, in some cases, include additional or alternative files that do not correspond to binary files.

The patch server 205 may determine a difference (e.g., a compilation difference 230) between the updated version of the code and the production version of the code based on the file difference. For example, the patch server 205 may identify files of one or more particular file types (e.g., java, .cs, .c, .cpp, .go, .py, .js, etc.) included in the file difference. In some examples, the one or more particular file types may be associated with binary file types. The patch server 205 may determine the compilation difference 230 based on the identified files included in the file difference (e.g., using a file matching check). In some examples, the patch server 205 may identify additional files that are not included in the file difference, but may be included in the compilation difference 230. For example, the patch server 205 may identify binary files (e.g., internal classes) that are associated with the file difference, but may not be included in the file difference. In some cases, the binary files identified at the patch server 205 may be a subset of the set of binary files associated with the file difference 225 received from the version control server 210. For example, the file difference 225 may include files corresponding to one or more binary files that are not different between the production version of the code and the updated version of the code.

The subset of binary files may be packaged into a software patch, and the software patch may be associated with the production version of the code. In some cases, a build tool (e.g., Maven, Ant, Gradle, Makefilc, CMake, Ninja, etc.) may be used to create and/or build the software patch. The software patch may contain executable code (e.g., .jar, .class, .exe, .dll, .o, one or more files containing an execution bit, etc.) associated with the one or more updates. In some cases, the software patch may be named based on an issue associated with the production version of the code and/or a version identifier associated with the production version of the code. Naming the software patch based on the issue and/or version identifier may decrease the likelihood of a user encountering errors when applying the software patch. For example, a user may determine a software patch name based on the issue and/or code version, and may reference a received software patch based on the issue and/or code version. Naming and/or building a software patch associated with an issue and/or code version may improve system efficiency. For example, a software patch may be saved by the patch server 205, and the software patch may be associated with an issue and/or a code version. In some examples, the patch server 205 may receive an indication of an issue associated with a production version of code, and may retrieve the saved software patch. This may, for example, reduce the resources (e.g., time resources, compute resource, etc.) used by the patch server 205. Additionally, the patch server 205, a user device, or a user may refrain from installing a software patch for a particular version of code if the version indicated in the patch name does not correspond to the version of the code. This may ensure that the software patch is compiled against the correct version of code.

FIG. 3 illustrates an example of a software update deployment system 300 that supports automated software patching for versioned code in accordance with aspects of the present disclosure. The software update deployment system 300 includes a patch server 305, a number of production servers, and a user device 310, which may be examples or components of one or more server and/or cloud platforms as described with reference to FIGS. 1 and 2. For example, the patch server 305 may be an example or component of a data center 120, a cloud platform 115, or a patch server 205. The user device 310 and application server 315 may be examples of or associated with cloud clients 105 or contacts 110, and the cloud-based server 320 may be a component of a cloud platform 115 as described with reference to FIG. 1.

The patch server 305 may represent aspects of an application server, communication server, data processing server, database server, cloud-based server, server cluster, virtual machine, container, or some similar data processing device or system. The patch server 305 may communicate with other devices such as a number of servers (e.g., application servers 315, cloud-based servers 320, etc.) and/or user devices 310. The patch server 305 may generate a software patch 325 (e.g., an incremental patch) associated with a production version of code and one or more updates to the production version of code. The patch server 305 may transmit the software patch 325 to a user (e.g., a user device 310, an application server 315, a cloud-based server 320, or some combination thereof). In some cases, the patch server 305 may receive a request message from a user device 310, and the patch server 305 may generate the software patch 325 based on the received request message.

The patch server 305 may transmit the software patch 325 to the user device 310, and, in some examples, the user device 310 may install the software patch 325 to a production version of code running on the user device 310. For example, the user device 310 may reference the software patch 325 through an environment variable and/or a classpath. In some examples, the user device 310 may move or copy the software patch 325 to an application server 315, and in additional or alternative examples, the patch server 305 may transmit the software patch 325 to the application server 315. The software patch 325 may be installed (e.g., referenced) based on the name of the software patch 325, the production version of the code, one or more issues associated with the production version of code, or any combination thereof. Installing the software patch 325 may involve overriding a set of existing binaries (e.g., binary files) in the production version of the code with a set of binaries provided in the software patch 325 to update the specific production version of the code. This installation process may effectively patch the binaries themselves (e.g., as opposed to one or more text files for the code) and may involve applying the software patch 325 to the particular environment of the requesting user, reducing the chance of future conflicts as more patches are applied.

In some cases, the patch server 305 may transmit the software patch 325 to a cloud-based server 320. The patch server 305 may additionally or alternatively install the software patch 325 at the cloud-based server 320. In some examples, the software patch 325 may be automatically installed and/or applied at the cloud-based server 320. For example, an installation procedure (e.g., shell script) may be performed at the cloud-based server 320 to install the software patch 325. In some cases, the installation procedure may be triggered by the cloud-based server 320 receiving a software patch 325. Additionally or alternatively, the patch server 305 may transmit an installation request to the cloud-based server 320, and the software patch 325 may be installed at the cloud-based server 320 based on the installation request. Automatically installing a software patch 325 may improve system performance and/or reduce the amount of user input for patching a production version of code. In this way, the software update deployment system 300 may patch a cloud-based version of code used by multiple users based on a request by a single user. Automatically applying a software patch 325 may decrease the amount of time a user spends maintaining a production version of code. In some examples, a software patch 325 may prevent software vulnerabilities in a production version of code from being exploited by malicious users.

FIG. 4 illustrates an example of a software patch creation process 400 that supports automated software patching for versioned code in accordance with aspects of the present disclosure. The software patch creation process 400 may be performed by a server 405 and may include receiving a patch request at 410, applying changes at 415, building an updated version of code at 420, and creating the patch at 425. In some examples, a patch server may perform one or more of the steps in the software patch creation process 400.

At 410, a server 405 (e.g., a patch server 205 or 305 as described with reference to FIGS. 2 and 3) may receive a patch request. The patch request may include an indication of a production version of code (e.g., a release version, a software edition, etc.) and/or an indication of one or more issues (e.g., bugs, features, vulnerabilities, etc.). For example, the server 405 may receive, as parameters, a version tag, an issue tracker identifier, and the specific commits to include in a software patch based on a patch request. In some cases, a user device may include a user interface supporting user requests for software patches. The user may input issues with a current version of the code installed for the user into the user interface, and the user device may transmit these issues to the server 405 as a patch request.

At 415, the server 405 may apply changes (e.g., updates) to the production version of code. The changes may be based on the one or more issues. In some examples, the changes may be commits in a code repository. For example, a patch server may checkout a production version of code (e.g., where the code is versioned using a tag) associated with the patch request. The patch server may apply (e.g., cherry pick) one or more updates (e.g., commits) to apply to the production version of the code. These commits may be written by a developer or administrative user based on the received patch request, automatically generated based on the received patch request, or identified in a code repository based on the patch request. In some cases, the patch server may resolve one or more conflicts (e.g., merge conflicts) that arise when applying the one or more updates to the production version of the code. In some cases, the patch server may resolve the conflicts with an automatic process. In some additional or alternative cases, the patch server may identify the conflicts and prompt a user to resolve the conflicts.

At 420, the server 405 may build and/or compile an updated version of code. The updated version of the code may be associated with the production version of the code and one or more changes applied to the production version of the code. The server 405 may compile the updated version of the code. In some cases, the server 405 may test the compiled code. In additional or alternative cases, the test server may test code that is not compiled (e.g., interpreted code). In some cases, the server 405 may package the updated code. The building and/or testing of the updated code may improve the robustness of the automatic software patching system, as the server 405 may identify and/or correct errors (e.g., compilation errors, runtime errors, test failures, etc.) before deploying the updated code to production code.

At 425, the server 405 may create a software patch. In some examples, the software patch may be associated with a compilation difference between the updated version of the code and the production version of the code. For example, the server 405 may identify files associated with a difference between the updated version of the code and the production version of the code that correspond to binary files (e.g., binary files, files that may be compiled into binary files, executable files, etc.). In some cases, the server 405 may determine additional files (e.g., internal class files) that are associated with the identified files. For example, the server 405 may retrieve a list of classes that are changed between the production version of code and the updated version of code and may additionally retrieve a list of class extensions for this list of changed classes (e.g., including nested extensions to the class extensions). In additional or alternative cases, the server 405 may refrain from identifying or adding files that are not associated with a difference between the updated version of the code and the production version of the code. The identified files and/or additional identified files may be used to create the software patch. For example, a build tool (e.g., Maven, Makefile, etc.) may be used to build a software patch based on the identified files and/or additional identified files. In some cases, the server 405 may not identify any files associated with a difference between the updated version of the code and the production version of the code. In such cases, the server 405 may notify or otherwise indicate that there is no compilation difference between the updated version of the code and the production version of the code.

The server 405 may create a patch across multiple modules and/or code repositories. For example, if a code change affects several modules, the server 405 may create a software patch in each module and may use a “mergePatches” function to merge the separate software patches into a single software patch for deployment. This may support separately executing code for different modules (e.g., the updated version of code is executed from a single module) while generating a single software patch for installation across a set of multiple modules.

FIG. 5 illustrates an example of a process flow 500 that supports automated software patching for versioned code in accordance with aspects of the present disclosure. The process flow 500 includes a patching server 505, a user device 510, and a version control server 515. These may be examples of the corresponding devices described with reference to FIGS. 1 through 4. The patching server 505 may implement automatic patching to generate a software update for a user device 510. Automatic patching may improve user experience and prevent security vulnerabilities. Alternative examples of the following may be implemented, where some steps are performed in a different order than described or are not performed at all. In some cases, steps may include additional features not mentioned below, or further steps may be added.

At 520, the patching server 505 may receive a request for a software patch (e.g., from a user device 510). In some cases, the received request may be associated with a version of production code (e.g., a release number) and/or one or more issues (e.g., bugs, desired features, etc.).

At 525, the patching server 505 may receive a production version of code. The production version of code may, for example, correspond to a software release, a software edition, a software version, etc. In some examples, the patching server 505 may receive the production version of code in response to a request for a production version of code. For example, the patching server 505 may transmit a production code request to the version control server 515 and may receive a production version of code from the version control server 515 and in response to the production code request.

At 530, the patching server 505 may receive a file difference. In some cases, the file difference may indicate differences between multiple versions of code. The patching server 505 may transmit a file difference request to the version control server 515. In some cases, the file difference request may indicate a production version of code and an updated version of code. The file difference may indicate which files are different between the production version of code and the updated version of code. The file difference may additionally or alternatively indicate what the differences are between the production version of code and the updated version of code.

At 535, the patching server 505 may analyze the file difference. For example, the patching server 505 may analyze the file difference to identify one or more binary (e.g., executable) files that are associated with the file difference. In some cases, the identified one or more binary files may be a subset of a set of binary files associated with the updated version of the code. For example, the updated version of the code may be associated with a set of binary files, and the patching server 505 may identify a subset of the set of binary files that corresponds to a difference between the production version of code and the updated version of code. The patching server 505 may filter out any files that are not different between the production version of the code and the updated version of the code at the binary level.

In some cases, the patching server 505 may create (e.g., package) a software patch based on the subset of binary files. For example, the patching server 505 may package the subset of binary files into an executable format (e.g., jar file, .exe file. .dll file, etc.). By filtering the binary files to determine the set of binary files that are different between the production version of the code and the updated version of the code, the patching server 505 may generate a software patch including a correct and minimal set of files that fulfills the request for the software patch.

At 540, the patching server 505 may deploy the software patch. The patching server 505 may transmit the software patch to a user device 510. In some examples, the user device 510 may add the software patch to a production version of code, for example, by overriding a set of files with the minimal set of files included in the software patch to fulfill the patch request received from the user device 510.

FIG. 6 shows a block diagram 600 of an apparatus 605 that supports automated software patching for versioned code in accordance with aspects of the present disclosure. The apparatus 605 may include an input module 610, a patching manager 615, and an output module 645. The apparatus 605 may also include a processor. Each of these components may be in communication with one another (e.g., via one or more buses). In some cases, the apparatus 605 may be an example of a user terminal, a database server, or a system containing multiple computing devices.

The input module 610 may manage input signals for the apparatus 605. For example, the input module 610 may identify input signals based on an interaction with a modem, a keyboard, a mouse, a touchscreen, or a similar device. These input signals may be associated with user input or processing at other components or devices. In some cases, the input module 610 may utilize an operating system such as iOS®, ANDROID®, MS-DOS®, MS-WINDOWS®, OS/2®, UNIX®, LINUX®, or another known operating system to handle input signals. The input module 610 may send aspects of these input signals to other components of the apparatus 605 for processing. For example, the input module 610 may transmit input signals to the patching manager 615 to support automated software patching for versioned code. In some cases, the input module 610 may be a component of an input/output (IO) controller 815 as described with reference to FIG. 8.

The patching manager 615 may include a code retrieval component 620, a code updating component 625, a file difference component 630, a binary difference component 635, and a patch packaging component 640. The patching manager 615 may be an example of aspects of the patching manager 705 or 810 described with reference to FIGS. 7 and 8.

The patching manager 615 and/or at least some of its various sub-components may be implemented in hardware, software executed by a processor, firmware, or any combination thereof. If implemented in software executed by a processor, the functions of the patching manager 615 and/or at least some of its various sub-components may be executed by a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described in the present disclosure. The patching manager 615 and/or at least some of its various sub-components may be physically located at various positions, including being distributed such that portions of functions are implemented at different physical locations by one or more physical devices. In some examples, the patching manager 615 and/or at least some of its various sub-components may be a separate and distinct component in accordance with various aspects of the present disclosure. In other examples, the patching manager 615 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

The code retrieval component 620 may retrieve, from a code repository at a server, a production version of code and one or more code updates to apply to the production version of the code. The code updating component 625 may determine an updated version of the code based on the production version of the code and the one or more code updates.

The file difference component 630 may retrieve, from the server, a file difference between the updated version of the code and the production version of the code, where the file difference corresponds to a set of binary files. The binary difference component 635 may determine a compilation difference between the updated version of the code and the production version of the code based on the file difference, where the compilation difference includes a subset of binary files of the set of binary files.

The patch packaging component 640 may package the subset of binary files into a software patch for the production version of the code. The output module 645 may manage output signals for the apparatus 605. For example, the output module 645 may receive signals from other components of the apparatus 605, such as the patching manager 615, and may transmit these signals to other components or devices. In some specific examples, the output module 645 may transmit output signals for display in a user interface, for storage in a database or data store, for further processing at a server or server cluster, or for any other processes at any number of devices or systems. In some cases, the output module 645 may be a component of an I/O controller 815 as described with reference to FIG. 8.

FIG. 7 shows a block diagram 700 of a patching manager 705 that supports automated software patching for versioned code in accordance with aspects of the present disclosure. The patching manager 705 may be an example of aspects of a patching manager 615 or a patching manager 810 described herein. The patching manager 705 may include a code retrieval component 710, a code updating component 715, a file difference component 720, a binary difference component 725, a patch packaging component 730, a request component 735, a name generator 740, a superset determining component 745, a binary file filtering component 750, a patch installing component 755, a code storing component 760, a patch merging component 765, and a code testing component 770. Each of these modules may communicate, directly or indirectly, with one another (e.g., via one or more buses).

The code retrieval component 710 may retrieve, from a code repository at a server, a production version of code and one or more code updates to apply to the production version of the code. The code updating component 715 may determine an updated version of the code based on the production version of the code and the one or more code updates. In some cases, the one or more code updates may include one or more commits in one or more branches of the code repository.

The file difference component 720 may retrieve, from the server, a file difference between the updated version of the code and the production version of the code, where the file difference corresponds to a set of binary files. The binary difference component 725 may determine a compilation difference between the updated version of the code and the production version of the code based on the file difference, where the compilation difference includes a subset of binary files of the set of binary files.

The patch packaging component 730 may package the subset of binary files into a software patch for the production version of the code. In some cases, the software patch includes a Java Archive (JAR) file including the subset of binary files.

The request component 735 may receive, from a user device, a request message for the software patch, where the request message indicates the production version of the code, and where retrieving the production version of code and the one or more code updates is based on the request message. In some examples, the request component 735 may transmit, to the user device, the software patch based on the packaging.

In some examples, the request component 735 may receive, based on a user input from a user device, a create patch command indicating the production version of the code and the one or more code updates. In some examples, the request component 735 may execute the create patch command, where retrieving the production version of code and the one or more code updates is based on executing the create patch command.

The name generator 740 may generate a name for the software patch, where the name is based on an identifier for the request message, the production version of the code, the one or more code updates, or a combination thereof. In some cases, the file difference includes a set of code classes. The superset determining component 745 may determine a superset of code classes including the set of code classes and any class extensions for the set of code classes, where the set of binary files corresponds to the superset of code classes.

Determining the compilation difference between the updated version of the code and the production version of the code may involve the binary file filtering component 750 filtering out one or more binary files of the set of binary files that are unchanged in the file difference to obtain the subset of binary files. In some examples, the production version of the code is implemented as a cloud-based production version of the code. The patch installing component 755 may automatically install the software patch for the cloud-based production version of the code. In some examples, automatically installing the software patch may involve the patch installing component 755 overriding a subset of existing binary files for the production version of the code with the subset of binary files for the updated version of the code.

The code storing component 760 may store the updated version of the code in the code repository at the server. The patch merging component 765 may merge the software patch for the production version of the code with at least a second software patch for a second production version of additional code.

The code testing component 770 may compile the updated version of the code. In some examples, the code testing component 770 may perform a validation test on the compiled updated version of the code, where the file difference is retrieved based on a successful result of the validation test.

FIG. 8 shows a diagram of a system 800 including a device 805 that supports automated software patching for versioned code in accordance with aspects of the present disclosure. The device 805 may be an example of or include the components of an application server or an apparatus 605 as described herein. The device 805 may include components for bi-directional data communications including components for transmitting and receiving communications, including a patching manager 810, an I/O controller 815, a database controller 820, memory 825, a processor 830, and a database 835. These components may be in electronic communication via one or more buses (e.g., bus 840).

The patching manager 810 may be an example of a patching manager 615 or 705 as described herein. For example, the patching manager 810 may perform any of the methods or processes described above with reference to FIGS. 6 and 7. In some cases, the patching manager 810 may be implemented in hardware, software executed by a processor, firmware, or any combination thereof.

e I/O controller 815 may manage input signals 845 and output signals 850 for the device 805. The I/O controller 815 may also manage peripherals not integrated into the device 805. In some cases, the I/O controller 815 may represent a physical connection or port to an external peripheral. In some cases, the I/O controller 815 may utilize an operating system such as iOS®, ANDROID®, MS-DOS®, MS-WINDOWS®, OS/2®, UNIX®, LINUX®, or another known operating system. In other cases, the I/O controller 815 may represent or interact with a modem, a keyboard, a mouse, a touchscreen, or a similar device. In some cases, the I/O controller 815 may be implemented as part of a processor. In some cases, a user may interact with the device 805 via the I/O controller 815 or via hardware components controlled by the I/O controller 815.

The database controller 820 may manage data storage and processing in a database 835. In some cases, a user may interact with the database controller 820. In other cases, the database controller 820 may operate automatically without user interaction. The database 835 may be an example of a single database, a distributed database, multiple distributed databases, a data store, a data lake, or an emergency backup database.

Memory 825 may include random-access memory (RAM) and read-only memory (ROM). The memory 825 may store computer-readable, computer-executable software including instructions that, when executed, cause the processor to perform various functions described herein. In some cases, the memory 825 may contain, among other things, a basic I/O system (BIOS) which may control basic hardware or software operation such as the interaction with peripheral components or devices.

The processor 830 may include an intelligent hardware device (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, the processor 830 may be configured to operate a memory array using a memory controller. In other cases, a memory controller may be integrated into the processor 830. The processor 830 may be configured to execute computer-readable instructions stored in a memory 825 to perform various functions (e.g., functions or tasks supporting automated software patching for versioned code).

FIG. 9 shows a flowchart illustrating a method 900 that supports automated software patching for versioned code in accordance with aspects of the present disclosure. The operations of method 900 may be implemented by an application server or its components as described herein. For example, the operations of method 900 may be performed by a patching manager as described with reference to FIGS. 6 through 8. In some examples, an application server may execute a set of instructions to control the functional elements of the application server to perform the functions described below. Additionally or alternatively, an application server may perform aspects of the functions described below using special-purpose hardware.

At 905, the application server may retrieve, from a code repository at a server, a production version of code and one or more code updates to apply to the production version of the code. The operations of 905 may be performed according to the methods described herein. In some examples, aspects of the operations of 905 may be performed by a code retrieval component as described with reference to FIGS. 6 through 8.

At 910, the application server may determine an updated version of the code based on the production version of the code and the one or more code updates. The operations of 910 may be performed according to the methods described herein. In some examples, aspects of the operations of 910 may be performed by a code updating component as described with reference to FIGS. 6 through 8.

At 915, the application server may retrieve, from the server, a file difference between the updated version of the code and the production version of the code, where the file difference corresponds to a set of binary files. The operations of 915 may be performed according to the methods described herein. In some examples, aspects of the operations of 915 may be performed by a file difference component as described with reference to FIGS. 6 through 8.

At 920, the application server may determine a compilation difference between the updated version of the code and the production version of the code based on the file difference, where the compilation difference includes a subset of binary files of the set of binary files. The operations of 920 may be performed according to the methods described herein. In some examples, aspects of the operations of 920 may be performed by a binary difference component as described with reference to FIGS. 6 through 8.

At 925, the application server may package the subset of binary files into a software patch for the production version of the code. The operations of 925 may be performed according to the methods described herein. In some examples, aspects of the operations of 925 may be performed by a patch packaging component as described with reference to FIGS. 6 through 8.

FIG. 10 shows a flowchart illustrating a method 1000 that supports automated software patching for versioned code in accordance with aspects of the present disclosure. The operations of method 1000 may be implemented by an application server or its components as described herein. For example, the operations of method 1000 may be performed by a patching manager as described with reference to FIGS. 6 through 8. In some examples, an application server may execute a set of instructions to control the functional elements of the application server to perform the functions described below. Additionally or alternatively, an application server may perform aspects of the functions described below using special-purpose hardware.

At 1005, the application server may receive, from a user device, a request message for a software patch, where the request message indicates a production version of code, and where retrieving the production version of code and one or more code updates is based on the request message. The operations of 1005 may be performed according to the methods described herein. In some examples, aspects of the operations of 1005 may be performed by a request component as described with reference to FIGS. 6 through 8.

At 1010, the application server may retrieve, from a code repository at a server, the production version of code and the one or more code updates to apply to the production version of the code. The operations of 1010 may be performed according to the methods described herein. In some examples, aspects of the operations of 1010 may be performed by a code retrieval component as described with reference to FIGS. 6 through 8.

At 1015, the application server may determine an updated version of the code based on the production version of the code and the one or more code updates. The operations of 1015 may be performed according to the methods described herein. In some examples, aspects of the operations of 1015 may be performed by a code updating component as described with reference to FIGS. 6 through 8.

At 1020, the application server may retrieve, from the server, a file difference between the updated version of the code and the production version of the code, where the file difference corresponds to a set of binary files. The operations of 1020 may be performed according to the methods described herein. In some examples, aspects of the operations of 1020 may be performed by a file difference component as described with reference to FIGS. 6 through 8.

At 1025, the application server may determine a compilation difference between the updated version of the code and the production version of the code based on the file difference, where the compilation difference includes a subset of binary files of the set of binary files. The operations of 1025 may be performed according to the methods described herein. In some examples, aspects of the operations of 1025 may be performed by a binary difference component as described with reference to FIGS. 6 through 8.

At 1030, the application server may package the subset of binary files into a software patch for the production version of the code. The operations of 1030 may be performed according to the methods described herein. In some examples, aspects of the operations of 1030 may be performed by a patch packaging component as described with reference to FIGS. 6 through 8.

At 1035, the application server may transmit, to the user device, the software patch based on the packaging. The operations of 1035 may be performed according to the methods described herein. In some examples, aspects of the operations of 1035 may be performed by a request component as described with reference to FIGS. 6 through 8.

FIG. 11 shows a flowchart illustrating a method 1100 that supports automated software patching for versioned code in accordance with aspects of the present disclosure. The operations of method 1100 may be implemented by an application server or its components as described herein. For example, the operations of method 1100 may be performed by a patching manager as described with reference to FIGS. 6 through 8. In some examples, an application server may execute a set of instructions to control the functional elements of the application server to perform the functions described below. Additionally or alternatively, an application server may perform aspects of the functions described below using special-purpose hardware.

At 1105, the application server may receive, based on a user input from a user device, a create patch command indicating a production version of code and one or more code updates. The operations of 1105 may be performed according to the methods described herein. In some examples, aspects of the operations of 1105 may be performed by a request component as described with reference to FIGS. 6 through 8.

At 1110, the application server may execute the create patch command, where retrieving the production version of code and the one or more code updates is based on executing the create patch command. The operations of 1110 may be performed according to the methods described herein. In some examples, aspects of the operations of 1110 may be performed by a request component as described with reference to FIGS. 6 through 8.

At 1115, the application server may retrieve, from a code repository at a server, the production version of code and the one or more code updates to apply to the production version of the code. The operations of 1115 may be performed according to the methods described herein. In some examples, aspects of the operations of 1115 may be performed by a code retrieval component as described with reference to FIGS. 6 through 8.

At 1120, the application server may determine an updated version of the code based on the production version of the code and the one or more code updates. The operations of 1120 may be performed according to the methods described herein. In some examples, aspects of the operations of 1120 may be performed by a code updating component as described with reference to FIGS. 6 through 8.

At 1125, the application server may retrieve, from the server, a file difference between the updated version of the code and the production version of the code, where the file difference corresponds to a set of binary files. The operations of 1125 may be performed according to the methods described herein. In some examples, aspects of the operations of 1125 may be performed by a file difference component as described with reference to FIGS. 6 through 8.

At 1130, the application server may determine a compilation difference between the updated version of the code and the production version of the code based on the file difference, where the compilation difference includes a subset of binary files of the set of binary files. The operations of 1130 may be performed according to the methods described herein. In some examples, aspects of the operations of 1130 may be performed by a binary difference component as described with reference to FIGS. 6 through 8.

At 1135, the application server may package the subset of binary files into a software patch for the production version of the code. The operations of 1135 may be performed according to the methods described herein. In some examples, aspects of the operations of 1135 may be performed by a patch packaging component as described with reference to FIGS. 6 through 8.

A method for managing software patches is described. The method may include retrieving, from a code repository at a server, a production version of code and one or more code updates to apply to the production version of the code, determining an updated version of the code based on the production version of the code and the one or more code updates, retrieving, from the server, a file difference between the updated version of the code and the production version of the code, where the file difference corresponds to a set of binary files, determining a compilation difference between the updated version of the code and the production version of the code based on the file difference, where the compilation difference includes a subset of binary files of the set of binary files, and packaging the subset of binary files into a software patch for the production version of the code.

An apparatus for managing software patches is described. The apparatus may include a processor, memory coupled with the processor, and instructions stored in the memory. The instructions may be executable by the processor to cause the apparatus to retrieve, from a code repository at a server, a production version of code and one or more code updates to apply to the production version of the code, determine an updated version of the code based on the production version of the code and the one or more code updates, retrieve, from the server, a file difference between the updated version of the code and the production version of the code, where the file difference corresponds to a set of binary files, determine a compilation difference between the updated version of the code and the production version of the code based on the file difference, where the compilation difference includes a subset of binary files of the set of binary files, and package the subset of binary files into a software patch for the production version of the code.

Another apparatus for managing software patches is described. The apparatus may include means for retrieving, from a code repository at a server, a production version of code and one or more code updates to apply to the production version of the code, determining an updated version of the code based on the production version of the code and the one or more code updates, retrieving, from the server, a file difference between the updated version of the code and the production version of the code, where the file difference corresponds to a set of binary files, determining a compilation difference between the updated version of the code and the production version of the code based on the file difference, where the compilation difference includes a subset of binary files of the set of binary files, and packaging the subset of binary files into a software patch for the production version of the code.

A non-transitory computer-readable medium storing first code for managing software patches is described. The first code may include instructions executable by a processor to retrieve, from a code repository at a server, a production version of code and one or more code updates to apply to the production version of the code, determine an updated version of the code based on the production version of the code and the one or more code updates, retrieve, from the server, a file difference between the updated version of the code and the production version of the code, where the file difference corresponds to a set of binary files, determine a compilation difference between the updated version of the code and the production version of the code based on the file difference, where the compilation difference includes a subset of binary files of the set of binary files, and package the subset of binary files into a software patch for the production version of the code.

Some examples of the method, apparatuses, and non-transitory computer-readable medium described herein may further include operations, features, means, or instructions for receiving, from a user device, a request message for the software patch, where the request message indicates the production version of the code, and where retrieving the production version of code and the one or more code updates may be based on the request message, and transmitting, to the user device, the software patch based on the packaging.

Some examples of the method, apparatuses, and non-transitory computer-readable medium described herein may further include operations, features, means, or instructions for generating a name for the software patch, where the name may be based on an identifier for the request message, the production version of the code, the one or more code updates, or a combination thereof.

Some examples of the method, apparatuses, and non-transitory computer-readable medium described herein may further include operations, features, means, or instructions for receiving, based on a user input from a user device, a create patch command indicating the production version of the code and the one or more code updates and executing the create patch command, where retrieving the production version of code and the one or more code updates may be based on executing the create patch command.

In some examples of the method, apparatuses, and non-transitory computer-readable medium described herein, the file difference may include a set of code classes and the method, apparatuses, and non-transitory computer-readable medium may further include operations, features, means, or instructions for determining a superset of code classes including the set of code classes and any class extensions for the set of code classes, where the set of binary files corresponds to the superset of code classes.

In some examples of the method, apparatuses, and non-transitory computer-readable medium described herein, determining the compilation difference between the updated version of the code and the production version of the code may include operations, features, means, or instructions for filtering out one or more binary files of the set of binary files that are unchanged in the file difference to obtain the subset of binary files.

In some examples of the method, apparatuses, and non-transitory computer-readable medium described herein, the production version of the code is implemented as a cloud-based production version of the code. Some examples of the method, apparatuses, and non-transitory computer-readable medium described herein may further include operations, features, means, or instructions for automatically installing the software patch for the cloud-based production version of the code.

In some examples of the method, apparatuses, and non-transitory computer-readable medium described herein, automatically installing the software patch may include operations, features, means, or instructions for overriding a subset of existing binary files for the production version of the code with the subset of binary files for the updated version of the code.

Some examples of the method, apparatuses, and non-transitory computer-readable medium described herein may further include operations, features, means, or instructions for storing the updated version of the code in the code repository at the server.

Some examples of the method, apparatuses, and non-transitory computer-readable medium described herein may further include operations, features, means, or instructions for merging the software patch for the production version of the code with at least a second software patch for a second production version of additional code.

Some examples of the method, apparatuses, and non-transitory computer-readable medium described herein may further include operations, features, means, or instructions for compiling the updated version of the code and performing a validation test on the compiled updated version of the code, where the file difference may be retrieved based on a successful result of the validation test.

In some examples of the method, apparatuses, and non-transitory computer-readable medium described herein, the software patch includes a JAR file including the subset of binary files.

In some examples of the method, apparatuses, and non-transitory computer-readable medium described herein, the one or more code updates include one or more commits in one or more branches of the code repository.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for managing software patches, comprising:
retrieving, from a code repository at a server, a production version of code and one or more code updates to apply to the production version of the code;
determining an updated version of the code based at least in part on the production version of the code and the one or more code updates;
retrieving, from the server, a file difference between the updated version of the code and the production version of the code, wherein the file difference corresponds to a set of binary files;
determining a compilation difference between the updated version of the code and the production version of the code based at least in part on the file difference, wherein the compilation difference comprises a subset of binary files of the set of binary files; and
packaging the subset of binary files into a software patch for the production version of the code.

2. The method of claim 1, further comprising:
receiving, from a user device, a request message for the software patch, wherein the request message indicates the production version of the code, and wherein retrieving the production version of code and the one or more code updates is based at least in part on the request message; and
transmitting, to the user device, the software patch based at least in part on the packaging.

3. The method of claim 2, further comprising:
generating a name for the software patch, wherein the name is based at least in part on an identifier for the request message, the production version of the code, the one or more code updates, or a combination thereof.

4. The method of claim 1, further comprising:
receiving, based at least in part on a user input from a user device, a create patch command indicating the production version of the code and the one or more code updates; and
executing the create patch command, wherein retrieving the production version of code and the one or more code updates is based at least in part on executing the create patch command.

5. The method of claim 1, wherein the file difference comprises a set of code classes, the method further comprising:
determining a superset of code classes comprising the set of code classes and any class extensions for the set of code classes, wherein the set of binary files corresponds to the superset of code classes.

6. The method of claim 1, wherein determining the compilation difference between the updated version of the code and the production version of the code comprises:
filtering out one or more binary files of the set of binary files that are unchanged in the file difference to obtain the subset of binary files.

7. The method of claim 1, wherein the production version of the code is implemented as a cloud-based production version of the code, the method further comprising:
automatically installing the software patch for the cloud-based production version of the code.

8. The method of claim 7, wherein automatically installing the software patch comprises:
overriding a subset of existing binary files for the production version of the code with the subset of binary files for the updated version of the code.

9. The method of claim 1, further comprising:
storing the updated version of the code in the code repository at the server.

10. The method of claim 1, further comprising:
merging the software patch for the production version of the code with at least a second software patch for a second production version of additional code.

11. The method of claim 1, further comprising:
compiling the updated version of the code; and
performing a validation test on the compiled updated version of the code, wherein the file difference is retrieved based at least in part on a successful result of the validation test.

12. The method of claim 1, wherein the software patch comprises a Java Archive (JAR) file comprising the subset of binary files.

13. The method of claim 1, wherein the one or more code updates comprise one or more commits in one or more branches of the code repository.

14. An apparatus for managing software patches, comprising:
a processor;
memory coupled with the processor; and
instructions stored in the memory and executable by the processor to cause the apparatus to:
retrieve, from a code repository at a server, a production version of code and one or more code updates to apply to the production version of the code;
determine an updated version of the code based at least in part on the production version of the code and the one or more code updates;
retrieve, from the server, a file difference between the updated version of the code and the production version of the code, wherein the file difference corresponds to a set of binary files;
determine a compilation difference between the updated version of the code and the production version of the code based at least in part on the file difference, wherein the compilation difference comprises a subset of binary files of the set of binary files; and
package the subset of binary files into a software patch for the production version of the code.

15. The apparatus of claim 14, wherein the instructions are further executable by the processor to cause the apparatus to:
receive, from a user device, a request message for the software patch, wherein the request message indicates the production version of the code, and wherein retrieving the production version of code and the one or more code updates is based at least in part on the request message; and
transmit, to the user device, the software patch based at least in part on the packaging.

16. The apparatus of claim 15, wherein the instructions are further executable by the processor to cause the apparatus to:
generate a name for the software patch, wherein the name is based at least in part on an identifier for the request message, the production version of the code, the one or more code updates, or a combination thereof.

17. The apparatus of claim 14, wherein the instructions are further executable by the processor to cause the apparatus to:
receive, based at least in part on a user input from a user device, a create patch command indicating the production version of the code and the one or more code updates; and
execute the create patch command, wherein retrieving the production version of code and the one or more code updates is based at least in part on executing the create patch command.

18. A non-transitory computer-readable medium storing first code for managing software patches, the first code comprising instructions executable by a processor to:
retrieve, from a code repository at a server, a production version of code and one or more code updates to apply to the production version of the code;
determine an updated version of the code based at least in part on the production version of the code and the one or more code updates;
retrieve, from the server, a file difference between the updated version of the code and the production version of the code, wherein the file difference corresponds to a set of binary files;
determine a compilation difference between the updated version of the code and the production version of the code based at least in part on the file difference, wherein the compilation difference comprises a subset of binary files of the set of binary files; and
package the subset of binary files into a software patch for the production version of the code.

19. The non-transitory computer-readable medium of claim 18, wherein the instructions are further executable to:
receive, from a user device, a request message for the software patch, wherein the request message indicates the production version of the code, and wherein retrieving the production version of code and the one or more code updates is based at least in part on the request message; and
transmit, to the user device, the software patch based at least in part on the packaging.

20. The non-transitory computer-readable medium of claim 18, wherein the instructions are further executable to:
receive, based at least in part on a user input from a user device, a create patch command indicating the production version of the code and the one or more code updates; and
execute the create patch command, wherein retrieving the production version of code and the one or more code updates is based at least in part on executing the create patch command.
